(19) United States
(12) Patent Application Publication
(10) Pub. No.: US 2009/0026969 A1
(43) Pub. Date: Jan. 29, 2009

(54) ORGANIC LIGHT EMITTING DEVICE

(76) Inventor: Woong Joo, Seoul (KR)

Correspondence Address: KED & ASSOCIATES, LLP, P.O. Box 221200, Chantilly, VA, 20153-1200, US

(21) Appl. No.: 12/015,031

(22) Filed: Jan. 16, 2008

(30) Foreign Application Priority Data
Jul. 24, 2007 (KR) 10-2007-0073990

(51) Int. Cl. H05B 41/16; G06F 3/038

(52) U.S. Cl. 315/169.3; 345/211

(57) ABSTRACT

An organic light emitting device is disclosed. The organic light emitting device includes a display unit on a substrate, the display unit including a plurality of subpixels, a plurality of monitor pixels positioned outside the display unit, a driver that supplies a data signal to the display unit in each of a plurality of subfields, a power supply unit that supplies a power to the display unit and the monitor pixels, and a sample hold unit connected to power terminals of the monitor pixels. When most significant bit is defined as n-bit, the sample hold unit samples a current supplied to the power terminals of the monitor pixels into a voltage in any one of the subfields corresponding to bit equal to or more than (n−2)-bit among the plurality of subfields, and transmits the sampled voltage to the power supply unit.

This application claims the benefit of Korean Patent Application No. 10-2007-0073990 filed on Jul. 24, 2007, which is hereby incorporated by reference.

### BACKGROUND

1. Field

An exemplary embodiment relates to a display device, and more particularly, to an organic light emitting device.

2. Description of the Related Art

An organic light emitting device is a self-emitting device including a light emitting layer between two electrodes.

The organic light emitting device may have a top emission structure and a bottom emission structure depending on an emission direction of light. The organic light emitting device may be classified into a passive matrix type organic light emitting device and an active matrix type organic light emitting device depending on a driving manner,

In the active matrix type organic light emitting device, when signals are supplied to a plurality of subpixels arranged on a display unit in a matrix format, a transistor, a capacitor, and an organic light emitting diode, which are positioned inside each subpixel, are driven to display an image.

However, driving characteristics of the active matrix type organic light emitting device change due to the degradation of subpixel elements such as the transistor, the capacitor, and the organic light emitting diode, and thus the display quality of the active matrix type organic light emitting device is reduced.

In the related art organic light emitting device, a method for compensating for changes in characteristics of the subpixels positioned inside the display unit using monitor pixels formed on a substrate outside the display unit has been variously proposed so as to the above-described problem.

For instance, there is a method in which a voltage or a current supplied to the monitor pixels are sampled and a voltage or a current to be supplied to each subpixel is controlled based on the sampled value. However, in the related art organic light emitting device, the accuracy of the sampling operation is reduced by a parasitic resistance of the monitor pixel and the subpixel.

### SUMMARY

An exemplary embodiment provides an organic light emitting device capable of improving the display quality and achieving a stable image display.

In one aspect, an organic light emitting device comprises a display unit on a substrate, the display unit including a plurality of subpixels, a plurality of monitor pixels positioned outside the display unit, a driver that supplies a data signal to the display unit in each of a plurality of subfields, a power supply unit that supplies a power to the display unit and the monitor pixels, and a sample hold unit connected to power terminals of the monitor pixels, wherein when most significant bit is defined as n-bit, the sample hold unit samples a current supplied to the power terminals of the monitor pixels into a voltage in any one of the subfields corresponding to bit equal to or more than (n−2)-bit among the plurality of subfields, and transmits the sampled voltage to the power supply unit.

In another aspect, an organic light emitting device comprises a display unit on a substrate, the display unit including a plurality of subpixels, a plurality of monitor pixels positioned outside the display unit, a driver that supplies a data signal to the display unit in each of a plurality of subfields of one frame, one frame including black time, a power supply unit that supplies a power to the display unit and the monitor pixels, and a sample hold unit connected to power terminals of the monitor pixels, wherein the sample hold unit samples a current supplied to the power terminals of the monitor pixels into a voltage in the black time of one frame and transmits the sampled voltage to the power supply unit.

In yet another aspect, an organic light emitting device comprises a display unit on a substrate, the display unit including a plurality of subpixels, a plurality of monitor pixels positioned outside the display unit, a driver that supplies a data signal to the display unit in each of a plurality of subfields of one frame, each subfield including scan time and display time, a power supply unit that supplies a power to the display unit and the monitor pixels, and a sample hold unit connected to power terminals of the monitor pixels, wherein the sample hold unit samples a current supplied to the power terminals of the monitor pixels into a voltage in any one of the subfields, in which the display time is longer than the scan time, and transmits the sampled voltage to the power supply unit.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 is a bock diagram of an organic light emitting device according to an exemplary embodiment;

FIG. 2 is a schematic plane view of the organic light emitting device;

FIGS. 3A and 3B are circuit diagrams of a subpixel of the organic light emitting device;

FIG. 4 is a partial block diagram of a structure of the organic light emitting device;

FIG. 5 is a circuit diagram of a structure of a sample hold unit of FIG. 4;

FIGS. 6 to 8 are waveform diagrams showing a relationship between a subfield and a control signal in the organic light emitting device;

FIG. 9 is a schematic circuit diagram of a structure of the organic light emitting device for explaining an influence of a parasitic resistance;

FIG. 10 is a waveform diagram of FIG. 9;

FIG. 11 is a plane view showing a structure of a subpixel of the organic light emitting device;

FIGS. 12A and 12B are cross-sectional views taken along line I-I′ of FIG. 11;

FIGS. 13A to 13C illustrate various implementations of a color image display method in the organic light emitting device; and

FIG. 14 is a cross-sectional view of the organic light emitting device.

### DETAILED DESCRIPTION

Reference will now be made in detail embodiments of the invention examples of which are illustrated in the accompanying drawings.

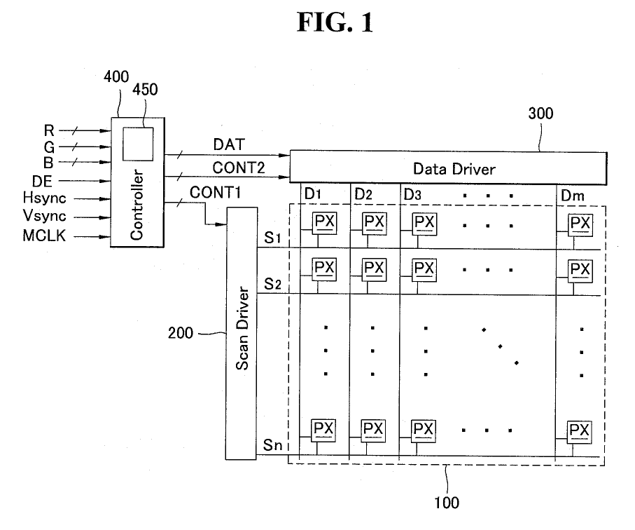

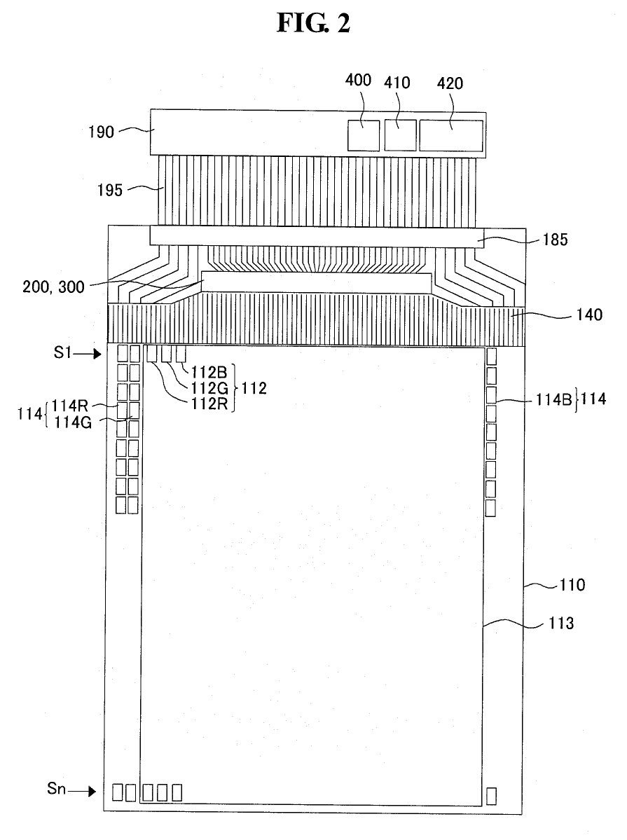

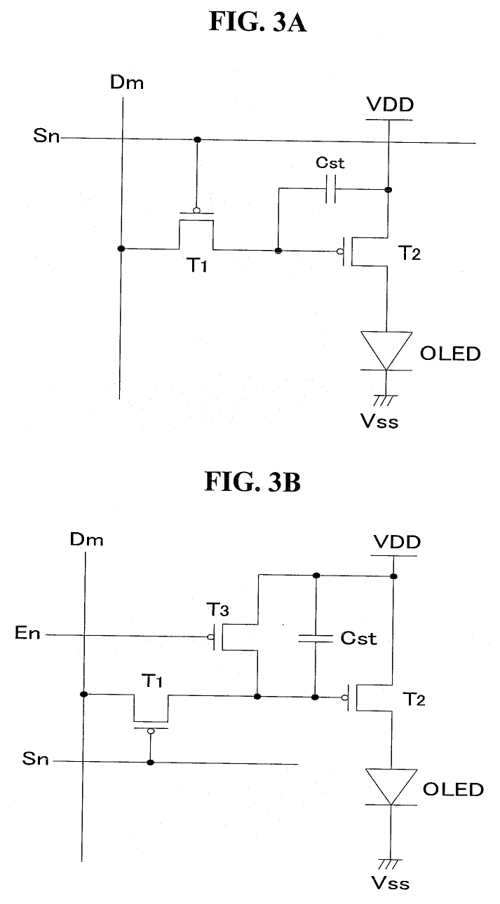

FIG. 1 is a bock diagram of an organic light emitting device according to an exemplary embodiment, FIG. 2 is a schematic plane view of the organic light emitting device, and FIGS. 3A and 3B are circuit diagrams of a subpixel of the organic light emitting device.

As shown in FIG. 1, the organic light emitting device according to the exemplary embodiment includes a display panel 100, a scan driver 200, a data driver 300, and a controller 400.

The display panel 100 includes a plurality of signal lines S1 to Sn and D1 to Dm, a plurality of power supply lines (not shown), and a plurality of subpixels PX arranged in a matrix format to be connected to the signal lines S1 to Sn and D1 to Dm and the power supply lines.

The plurality of signal lines S1 to Sn and D1 to Dm may include the plurality of scan lines S1 to Sn for transmitting scan signals and the plurality of data lines D1 to Dm for transmitting data signals. Each power supply line may transmit voltages such as a power voltage VDD to each subpixel PX.

Although the signal lines include the scan lines S1 to Sn and the data lines D1 to Dm in FIG. 1, the exemplary embodiment is not limited thereto. The signal lines may further include erase lines (not shown) for transmitting erase signals depending on a driving maimer.

However, the erase lines may not be used to transmit the erase signals. The erase signal may be transmitted through another signal line. For instance, although it is not shown, the erase signal may be supplied to the display panel 100 through the power supply line in case that the power supply line for supplying the power voltage VDD is formed.

As shown in FIG. 3A, the subpixel PX may include a switching thin film transistor T1 transmitting a data signal in response to a scan signal transmitted through the scan line Sn, a capacitor Cst storing the data signal, a driving thin film transistor T2 producing a driving current corresponding to a voltage difference between the data signal stored in the capacitor Cst and the power voltage VDD, and a light emitting diode (OLED) emitting light corresponding to the driving current.

As shown in FIG. 3B, the subpixel PX may include a switching thin film transistor Ti transmitting a data signal in response to a scan signal transmitted through the scan line Sn, a capacitor Cst storing the data signal, a driving thin film transistor T2 producing a driving current corresponding to a voltage difference between the data signal stored in the capacitor Cst and the power voltage VDD, a light emitting diode (OLED) emitting light corresponding to the driving current, and an erase switching thin film transistor T3 erasing the data signal stored in the capacitor Cst in response to an erase signal transmitted through an erase line En.

When the display device is driven in a digital driving manner that represents a gray scale by dividing one frame into a plurality of subfields, the pixel circuit of FIG. 3B can control a light emitting time by supplying the erase signal to the subfield PX whose the light-emission time is shorter than an addressing time. The pixel circuit of FIG. 3B has an advantage capable of reducing a minimum luminance of the display device.

A difference between driving voltages, e.g., the power voltages VDD and Vss of the organic light emitting device may change depending on the size of the display panel 100 and a driving manner. A magnitude of the driving voltage is shown in the following Tables 1 and 2. Table 1 indicates a driving voltage magnitude in case of a digital driving manner, and Table 2 indicates a driving voltage magnitude in case of an analog driving manner.

TABLE 1

| | VDD-Vss | | |
|---|---|---|---|
| Size (S) of display panel | (R) | VDD-Vss (G) | VDD-Vss (B) |
| S < 3 inches | 3.5-10 (V) | 3.5-10 (V) | 3.5-12 (V) |
| 3 inches < S < 20 inches | 5-15 (V) | 5-15 (V) | 5-20 (V) |
| 20 inches < S | 5-20 (V) | 5-20 (V) | 5-25 (V) |

TABLE 2

| Size (S) of display panel | VDD-Vss (R, G, B) |
|---|---|
| S < 3 inches | 4~20 (V) |
| 3 inches < S < 20 inches | 5~25 (V) |
| 20 inches < S | 5~30 (V) |

Referring again to FIG. 1, the scan driver 200 is connected to the scan lines S1 to Sn to apply scan signals capable of turning on the switching thin film transistor T1 to the scan lines S1 to Sn, respectively.

The data driver 300 is connected to the data lines D1 to Dm to apply data signals indicating an output video signal DAT′ to the data lines D1 to Dm, respectively. The data driver 300 may include at least one data driving integrated circuit (IC) connected to the data lines D1 to Dm.

The data driving IC may include a shift register, a latch, a digital-to-analog (DA) converter, and an output buffer which are connected to one another in the order named.

When a horizontal sync start signal (STH) (or a shift clock signal) is received, the shift register can transmit the output video signal DAT′ to the latch in response to a data clock signal (HLCK). In case that the data driver 300 includes a plurality of data driving ICs, a shift register of a data driving IC can transmit a shift clock signal to a shift register of a next data driving IC.

The latch memorizes the output video signal DAT′, selects a gray voltage corresponding to the memorized output video signal DAT′ in response to a load signal, and transmits the gray voltage to the output buffer, output video signal DAT′ and transmits the gray voltage to the output buffer,

The output buffer outputs an output voltage (serving as a data signal) received from the DA converter to the data lines D1 to Dm, and maintains the output of the output voltage for 1 horizontal period (1H).

The controller 400 controls operations of the scan driver 200 and the data driver 300. The controller 400 may include a signal conversion unit 450 that gamma-converts input video signals R, G and B into the output video signal DAT′ and produces the output video signal DAT′.

The controller 400 produces a scan control signal CONT1 and a data control signal CONT2, and the like. Then, the controller 400 outputs the scan control signal CONT1 to the scan driver 200 and outputs the data control signal CONT2 and the processed output video signal DAT′ to the data driver 300.

The controller 400 receives the input video signals R, G and B and an input control signal for controlling the display of the input video signals R, G and B from a graphic controller (not shown) positioned outside the organic light emitting device. Examples of the input control signal include a vertical sync signal Vsync, a horizontal sync signal Hsync, a main clock signal MCLK and a data enable signal DE.

Each of the driving devices 200, 300 and 400 may be directly mounted on the display panel 100 in the form of at least one IC chip, or may be attached to the display panel 100 in the form of a tape carrier package (TCP) in a state where the driving devices 200, 300 and 400 each are mounted on a flexible printed circuit film (not shown), or may be mounted on a separate printed circuit board (not shown). Alternatively, each of the driving devices 200, 300 and 400 may be integrated on the display panel 100 together with elements such as the plurality of signal lines S1 to Sn and D1 to Dm or the thin film transistors T1, T2 and T3.

Further, the driving devices 200, 300 and 400 may be integrated into a single chip. In this case, at least one of the driving devices 200, 300 and 400 or at least one circuit element constituting the driving devices 200, 300 and 400 may be positioned outside the single chip.

As shown in FIG. 2, the organic light emitting device according to the exemplary embodiment includes a substrate 110, and a display unit 113 including a plurality of subpixels 112 arranged on the substrate 110 in a matrix format.

Monitor pixels 114 are positioned at right and left sides of the substrate 110 outside the display unit 113 to correspond to an emission color of each of the subpixels 112. The monitor pixels 114 and the subpixels 112 may be commonly connected to a cathode electrode. In other words, the monitor pixels 114 and the subpixels 112 may use an equal ground level.

The monitor pixels 114 may be positioned on each of the scan lines S1 to Sn used to supply scan signals to the display unit 113, or may be selectively positioned on one half of the scan lines S1 to Sn.

A plurality of lines 140 connected to the monitor pixels 114 and the subpixels 112 are positioned on the substrate 110 outside the display unit 113. The plurality of lines 140 include power supply lines supplying a voltage to the subpixels 112 and supplying a current to the monitor pixels 114, and scan lines and data lines respectively supplying a scan signal and a data signal to the subpixels 112.

The drivers 200 and 300 are positioned on a lower part of the substrate 110 outside the display unit 113. The drivers 200 and 300 are connected to the scan lines and the data lines to supply a scan signal and a data signal to the subpixels 112.

The scan driver 200 and the data driver 300 may be separately positioned at both sides of the substrate 110 outside the display unit 113. Further, the data driver 300 and the scan driver 200 may be positioned outside the substrate 110, and may be connected to the substrate 110.

A pad unit 185 may be positioned on the lower part of the substrate 110 outside the display unit 113. The pad unit 185 may be electrically connected to a printed circuit board 190, and the printed circuit board 190 may be connected to the substrate 110 through a flexible cable (for example, a flexible printed circuit (FPC) 195)

A sample hold unit 410 is positioned on the printed circuit board 190. The sample hold unit 410 is connected to power terminals of the monitor pixels 114 to sample a current supplied to the monitor pixels 114 into a voltage, and to output a feedback signal capable of controlling a voltage to be supplied to the subpixels 112 based on the sampled voltage.

A power supply unit 420 is positioned on the printed circuit board 190. The power supply unit 420 is connected to some power supply lines of the plurality of lines 140 to supply a voltage to the subpixels 112 and to supply a current to the monitor pixels 114. The power supply unit 420 includes a voltage source supplying a voltage to the subpixels 112 and a current source supplying a current to the monitor pixels 114.

The current source of the power supply unit 420 may include one current source when a similar amount of current is supplied to all of the monitor pixels 114, and may include current sources corresponding to emission colors of the monitor pixels 114 when a different amount of current is supplied to each of all of the monitor pixels 114.

The controller 400 is positioned on the printed circuit board 190 to supply a control signal to at least one of the drivers 200 and 300, the monitor pixels 114, the power supply unit 420, or the sample hold unit 410. The controller 400 outputs a control signal capable of controlling an interworking device (for example, the power supply unit 420, the sample hold unit 410, and the like).

An image memory and a processor, and the like, may be further positioned on the printed circuit board 190.

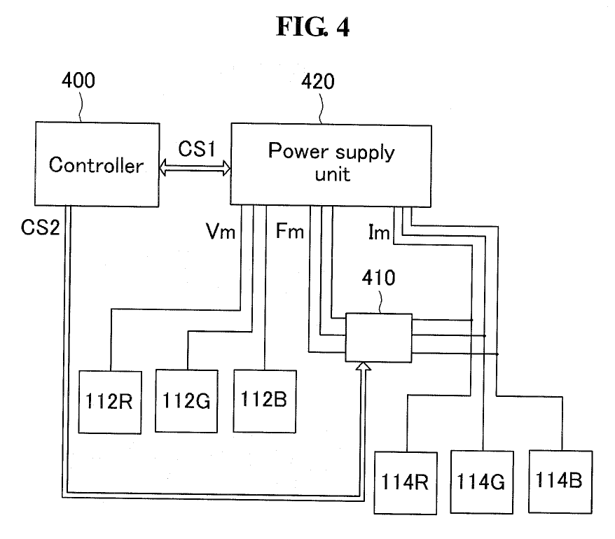

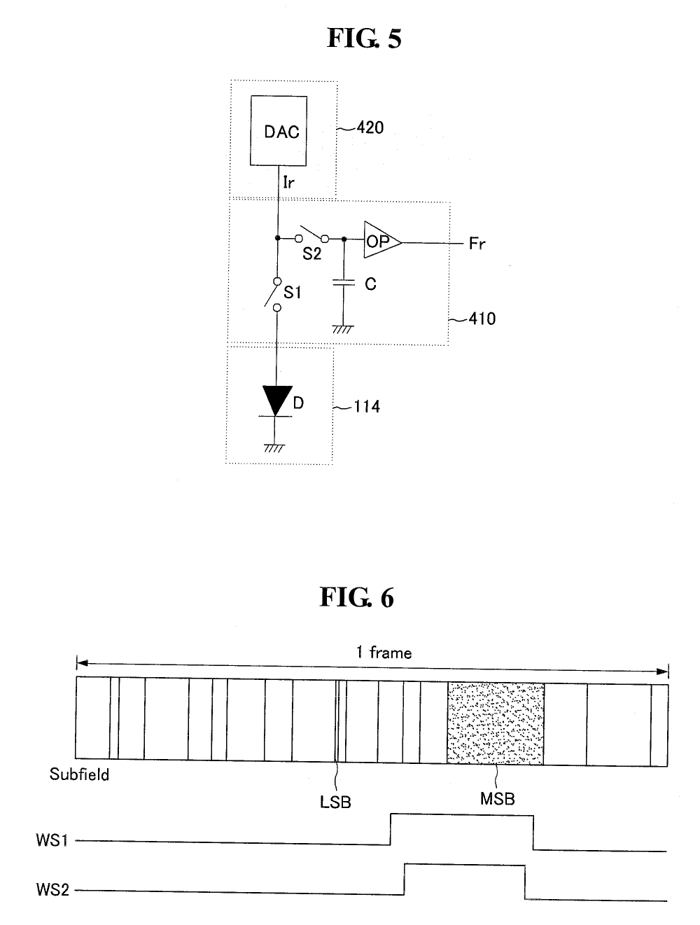

FIG. 4 is a partial block diagram of a structure of the organic light emitting device, and FIG. 5 is a circuit diagram of a structure of a sample hold unit of FIG. 4.

FIG. 4 shows three subpixels 112R, 112G, and 112B and three monitor pixels 114R, 14G, and 114B corresponding to the three subpixels 112R, 112G, and 112B, respectively. Also, FIG. 4 shows the power supply unit 420 supplying a voltage to the subpixels 112R, 112G, and 112B and a current to the monitor pixels 114R, 114G, and 114B, the sample hold unit 410 sampling the current supplied to the monitor pixels 114R, 14G, and 114B into a voltage, and the controller 400 supplying a control signal to the power supply unit 420 and the sample hold unit 410.

A current source of the power supply unit 420 outputs a current Im, and the output current Im is supplied to the monitor pixels 114R, 114G, and 114B. The sample hold unit 410 connected to power terminals of the monitor pixels 114R, 114G, and 114B samples the current Im supplied to the monitor pixels 114R, 114G, and 114B into a voltage, and transmits a sampled feedback value Fm to the power supply unit 420. Then, the power supply unit 420 controls a voltage Vm to be supplied to the subpixels 112R, 112G, and 112B based on the sampled feedback value Fm.

The controller supplies control signals CS1 and CS2 to the power supply unit 420 and the sample hold unit 410 that interwork each other, respectively, to control the power supply unit 420 and the sample hold unit 410.

FIG. 5 shows the sample hold unit 410 of FIG. 4 connected to the power supply unit 420 and a power terminal of the monitor pixel 114.

The sample hold unit 410 may include a first switch S1, a second switch S2, a capacitor C, an amplifier OP. The first switch S1 performs a switch operation so as to supply a current Ir to the monitor pixel 114. The second switch S2 performs a switch operation so as to selectively sample the current Ir supplied to the monitor pixel 114. The capacitor C samples the current Ir supplied to the monitor pixel 114 into a voltage. The amplifier OP amplifies the voltage sampled by the capacitor C and transmits the amplified voltage to the power supply unit 420.

A feedback value Fr sampled by the amplifier OP is transmitted to the power supply unit 420. If the organic light emitting device has a device, that receives the feedback value Fr and controls a voltage to be supplied to the subpixel 112, outside the power supply unit 420, the feedback value Fr may be transmitted to not the power supply unit 420 but the device controlling the voltage to be supplied to the subpixel 112.

In other words, the sample hold unit 410 samples the feedback value Fr in responses to a control signal output from the controller 400 and transmits the sampled feedback value Fr to the power supply unit 420.

Therefore, when the driver supplies a data signal to the display unit, the controller 400 supplies control signals to the first and second switches S1 and S2, respectively, so that the sample hold unit 410 samples the current Ir supplied to the power terminal of the monitor pixel 114 into a voltage in some or black time of a plurality of subfields.

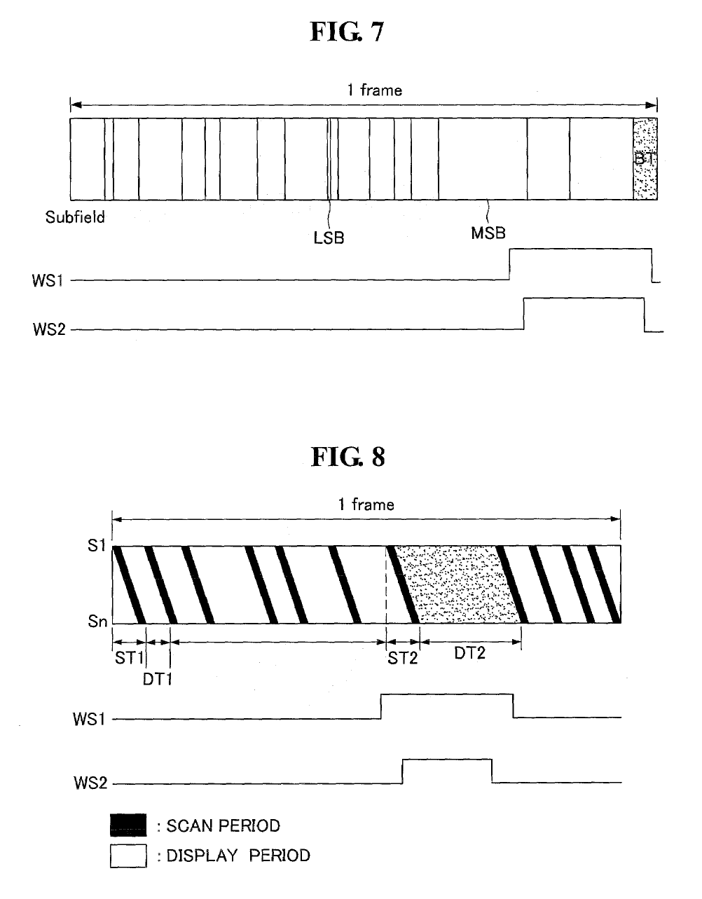

FIGS. 6 to 8 are waveform diagrams showing a relationship between a subfield and a control signal in the organic light emitting device.

In FIG. 6, a data signal is supplied in each of a plurality of subfields included in one frame. Each subfield may include a scan period and a display period.

The plurality of subfields may be arranged in order from the subfield corresponding to least significant bit (LSB) to the subfield corresponding to most significant bit (MSB), or in reverse order. Further, the plurality of subfields may be randomly arranged in no particular order. FIG. 6 shows a subfield structure in which the subfield corresponding to least significant bit (LSB) and the subfield corresponding to most significant bit (MSB) are randomly arranged among the plurality of subfields.

When the driver supplies a data signal to the display unit, the controller 400 supplies control signals WS1 and WS2 to the first and second switches S1 and S2 of the sample hold unit 410, respectively, so that the sample hold unit 410 samples the current Ir supplied to the power terminal of the monitor pixel 114 into a voltage in any one of the subfields corresponding to bit equal to or more than (n−2)-bit among the plurality of subfields. In FIG. 6, the most significant bit is defined as n-bit.

Accordingly, supposing that the most significant bit is 8-bit (n-bit), the controller 400 supplies the control signals WS1 and WS2 to the first and second switches S1 and S2 of the sample hold unit 410, respectively, so that the sample hold unit 410 samples the current Ir supplied to the power terminal of the monitor pixel 114 into a voltage in any one of the subfields corresponding to 6, 7, and 8-bit.

As shown in FIG. 7, when the driver supplies a data signal to the display unit, the sample hold unit 410 connected to the power terminal of the monitor pixel 114 samples a current supplied to the power terminal of the monitor pixel 114 into a voltage in black time included in one frame and transmits the sampled voltage to the power supply unit 420 so as to control a voltage to be supplied to the display unit.

In FIG. 7, a data signal is supplied in each of a plurality of subfields included in one frame. Each subfield may include a scan period and a display period.

The plurality of subfields may be arranged in order from the subfield corresponding to least significant bit (LSB) to the subfield corresponding to most significant bit (MSB), or in reverse order. Further, the plurality of subfields may be randomly arranged in no particular order. FIG. 7 shows a subfield structure in which the subfield corresponding to least significant bit (LSB) and the subfield corresponding to most significant bit (NISB) are randomly arranged among the plurality of subfields.

One frame may include black time (BT) during which the subpixels do not emit light. The black time may occupy the left-most period or the right-most period of one frame.

When the driver outputs a data signal stored in a memory, a conversion unit is positioned between the memory and the driver, and one frame can include the black time (BT) using the conversion unit. However, the exemplary embodiment is not limited thereto. For instance, one frame can include the black time (BT) using a lookup table. The lookup table can set the number of subfields when the data signal is converted in each subfield.

Accordingly, when the driver supplies a data signal to the display unit, the controller 400 shown in FIGS. 4 and 5 supplies control signals WS1 and WS2 to the first and second switches S1 and S2 of the sample hold unit 410, respectively, so that the sample hold unit 410 samples the current Ir supplied to the power terminal of the monitor pixel 114 into a voltage in the black time (BT) of one frame.

In FIG. 8, a data signal is supplied in each of a plurality of subfields included in one frame. Each subfield may include a scan period and a display period.

The plurality of subfields may be arranged in order from the subfield corresponding to least significant bit (LSB) to the subfield corresponding to most significant bit (MSB), or in reverse order. Further, the plurality of subfields may be randomly arranged in no particular order. FIG. 8 shows a subfield structure in which the subfield corresponding to least significant bit (LSB) and the subfield corresponding to most significant bit (MSB) are randomly arranged among the plurality of subfields.

When the driver supplies a data signal to the display unit, the controller 400 supplies control signals WS1 and WS2 to the first and second switches S1 and S2 of the sample hold unit 410, respectively, so that the sample hold unit 410 samples the current Ir supplied to the power terminal of the monitor pixel 114 into a voltage in one subfield of the subfields when display times DT1 and DT2 are longer than scan times ST1 and ST2 among the plurality of subfields.

The scan times ST1 and ST2 is time required to supply scan signals from the first scan line S1 to the last scan line Sn in the plurality of scan lines S 1 to Sn.

The display times DT1 and DT2 is time required to supply an erase signal or to supply a scan signal in the next subfield after a scan signal is supplied to one scan line of the plurality of scan lines S1 to Sn.

As shown in FIG. 8, the controller 400 does not supply control signals WS1 and WS2 to the first and second switches S1 and S2 of the sample hold unit 410 in the subfield when the display time DT1 is shorter than the scan time ST1 among the plurality of subfields. In other words, the sampling operation is not performed in the subfield when the display time DT1 is shorter than the scan time ST1.

However, when the driver supplies a data signal to the display unit, the controller 400 supplies the control signals WS1 and WS2 to the first and second switches S1 and S2 of the sample hold unit 410, respectively, so that the sample hold unit 410 samples the current Ir supplied to the power terminal of the monitor pixel 114 into a voltage in one subfield of the subfields when the display time DT2 is longer than the scan time ST2 among the plurality of subfields.

In the organic light emitting device according to the exemplary embodiment in FIGS. 6 to 8, the monitor pixel 114 and the sample hold unit 410 can indirectly monitor a degradation state or a demand of the subpixel 112. Accordingly, the subpixel 112 can receive a power suitable for a degradation state of the subpixel 112 from the power supply unit 420, and thus a reduction in light emitting characteristics of the subpixel 112 can solved.

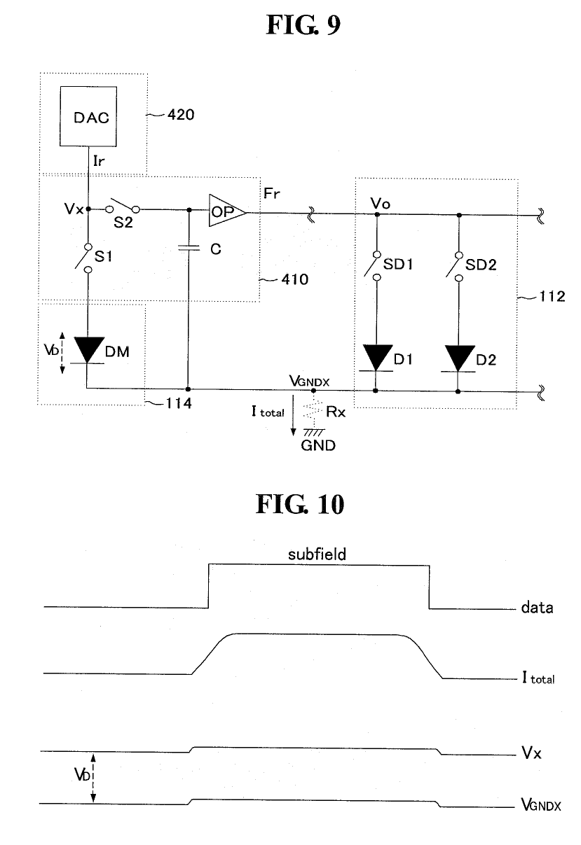

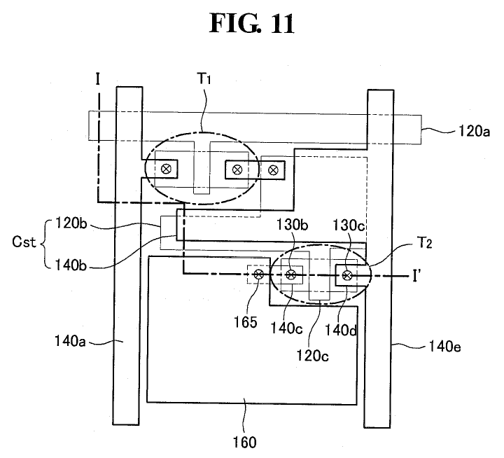

When the sample hold unit 410 samples the current Ir supplied to the power terminal of the monitor pixel 114 into the voltage, the subpixel 112 and the monitor pixel 114 commonly uses an equal ground level. Therefore, the generation of a sampling error caused by a rise in the ground level can be minimized. This will be described with reference to FIGS. 9 and 10.

FIG. 9 is a schematic circuit diagram of a structure of the organic light emitting device for explaining an influence of a parasitic resistance, and FIG. 10 is a waveform diagram of FIG. 9.

FIG. 9 shows the power supply unit 420, the sample hold unit 410, and the monitor pixel 114 and the subpixel 112 that are connected to a common cathode (i.e., common ground GND).

As shown in FIG. 10, when a data signal output from the driver is supplied to the subpixels 112 in each of the plurality of subfields, a total amount Iₜₒₜₐₗ of current flowing in the ground GND rises in a light emitting area of the subpixel 112.

Voltages V_{X} and V_{GNDX} at both terminals of the monitor pixel 114 rise in the light emitting area of the subpixel 112. A rise in the voltages V_{X} and V_{GNDX} may cause a difference V_{D} between voltages at both terminals of an organic light emitting diode DM included in the monitor pixel 114.

The voltages V_{X} and V_{GNDX} mainly rise in low bit in which a light emitting time interval is short in each subfield. However, the organic light emitting device according to the exemplary embodiment performs the sampling operation using the sample hold unit 410 in the subfield corresponding to bit equal to or more than (n−2)-bit in which a light emitting time interval is long or in the subfield in which the display time is longer than the scan time. Further, the organic light emitting device according to the exemplary embodiment performs the sampling operation using the sample hold unit 410 in the black time of one frame.

In FIG. 9, Vo indicates a voltage at the power terminal of the subpixel 112, SD1 and SD2 indicate a transistor driving the scan signal and the data signal supplied to the subpixel 112, and D1 and D2 indicate the organic light emitting diode included in the subpixel 112.

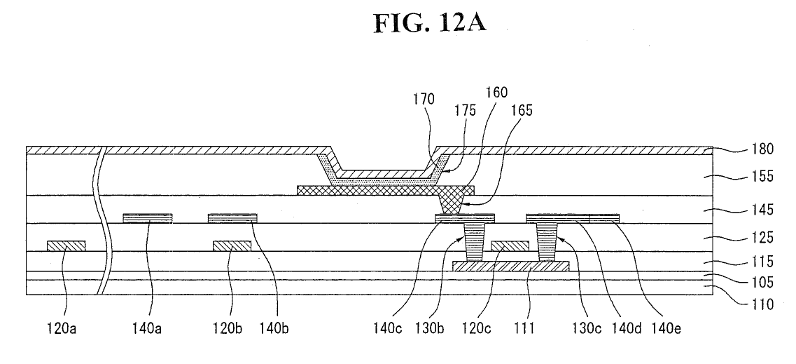

FIG. 11 is a plane view showing a structure of a subpixel of the organic light emitting device.

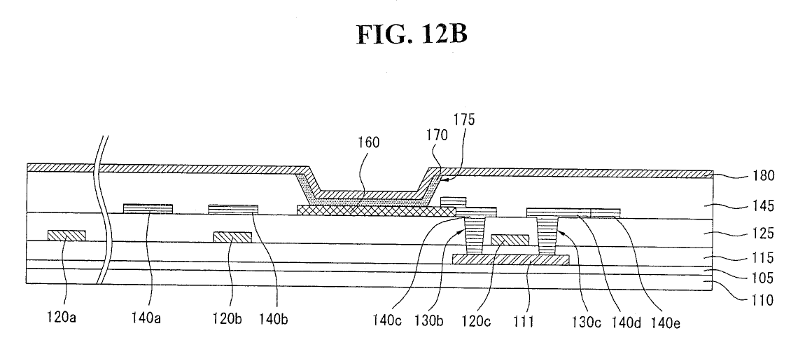

FIGS. 11, 12A and 12B show a structure of the subpixel of the organic light emitting device according to the exemplary embodiment. This structure includes the substrate 110 having a plurality of subpixel and non-subpixel areas. As shown, for instance, in FIG. 11, the subpixel area and the non-subpixel area may be defined by a scan line 120a that extends in one direction, a data line 140a that extends substantially perpendicular to the scan line 120a, and a power supply line 140e that extends substantially parallel to the data line 140a.

The subpixel area may include a switching thin film transistor T1 connected to the scan line 120a and the data line 140a, a capacitor Cst connected to the switching thin film transistor T1 and the power supply line 140e, and a driving thin film transistor T2 connected to the capacitor Cst and the power supply line 140e. The capacitor Cst may include a capacitor lower electrode 120b and a capacitor upper electrode 140b.

The subpixel area may also include a light emitting diode, which includes a first electrode 160 electrically connected to the driving thin film transistor T2, a light emitting layer (not shown) on the first electrode 160, and a second electrode (not shown). The non-subpixel area may include the scan line 120a, the data line 140a and the power supply line 140e.

FIGS. 12A and 12B are cross-sectional views taken along line I-I′ of FIG. 11.

As shown in FIG. 12A, a buffer layer 105 is positioned on the substrate 110. The buffer layer 105 prevents impurities (e.g., alkali ions discharged from the substrate 110) from being introduced during formation of the thin film transistor in a succeeding process. The buffer layer 105 may be selectively formed using silicon oxide (SiO2), silicon nitride (SiNX), or using other materials. The substrate 110 may be formed of glass, plastic or metal.

A semiconductor layer 111 is positioned on the buffer layer 105. The semiconductor layer 111 may include amorphous silicon or crystallized polycrystalline silicon. The semiconductor layer 111 may include a source region and a drain region including p-type or n-type impurities. The semiconductor layer 111 may include a channel region in addition to the source region and the drain region.

A first insulating layer 115, which may be a gate insulating layer, is positioned on the semiconductor layer 111. The first insulating layer 115 may include a silicon oxide (SiO_{X}) layer, a silicon nitride (SiN_{X}) layer, or a multi-layered structure or a combination thereof.

A gate electrode 120c is positioned on the first insulating layer 115 in a given area of the semiconductor layer 111, e.g., at a location corresponding to the channel region of the semiconductor layer 111 when impurities are doped. The scan line 120a and the capacitor lower electrode 120b may be positioned on the same formation layer as the gate electrode 120c.

The gate electrode 120c may be formed of any one selected from the group consisting of molybdenum (Mo), aluminum (Al), chromium (Cr), gold (Au), titanium (Ti), nickel (Ni), neodymium (Nd) and copper (Cu), or a combination thereof, The gate electrode 120c may have a multi-layered structure formed of Mo, Al, Cr, Au, Ti, Ni, Nd, or Cu, or a combination thereof. The gate electrode 120c may have a double-layered structure including Mo/Al—Nd or Mo/Al.

The scan line 120a may be formed of any one selected from the group consisting of Mo, Al, Cr, Au, Ti, Ni, Nd, or Cu, or a combination thereof. The scan line 120a may have a multi-layered structure formed of Mo, Al, Cr, Au, Ti, Ni, Nd, or Cu, or a combination thereof. The scan line 120a may have a double-layered structure including Mo/Al—Nd or Mo/Al.

A second insulating layer 125, which may be an interlayer dielectric, is positioned on the substrate 110 on which the scan line 120a, the capacitor lower electrode 120b and the gate electrode 120c are positioned. The second insulating layer 125 may include a silicon oxide (SiO_{X}) layer, a silicon nitride (SiN_{X}) layer, or a multi-layered structure or a combination thereof.

Contact holes 130b and 130c are positioned inside the second insulating layer 125 and the first insulating layer 115 to expose a portion of the semiconductor layer 111.

A drain electrode 140c and a source electrode 140d are positioned in the subpixel area to be electrically connected to the semiconductor layer 111 through the contact holes 130b and 130c passing through the second insulating layer 125 and the first insulating layer 115.

The drain electrode 140c and the source electrode 140d may have a single-layered structure or a multi-layered structure. When the drain electrode 140c and the source electrode 140d have the single-layered structure, the drain electrode 140c and the source electrode 140d may be formed of Mo, Al, Cr, Au, Ti, Ni, Nd, or Cu, or a combination thereof.

When the drain electrode 140c and the source electrode 140d have the multi-layered structure, the drain electrode 140c and the source electrode 140d may have a double-layered structure including Mo/Al—Nd or a triple-layered structure including Mo/Al/Mo or Mo/Al—Nd/Mo.

The data line 140a, the capacitor upper electrode 140b, and the power supply line 140e may be positioned on the same formation layer as the drain electrode 140c and the source electrode 140d.

The data line 140a and the power supply line 140e positioned in the non-subpixel area may have a single-layered structure or a multi-layered structure. When the data line 140a and the power supply line 140e have the single-layered structure, the data line 140a and the power supply line 140e may be formed of Mo, Al, Cr, Au, Ti, Ni, Nd, or Cu, or a combination thereof.

When the data line 140a and the power supply line 140e have the multi-layered structure, the data line 140a and the power supply line 140e may have a double-layered structure including Mo/Al—Nd or a triple-layered structure including Mo/Al/Mo or Mo/Al—Nd/Mo. The data line 140a and the power supply line 140e may have a triple-layered structure including Mo/Al—Nd/Mo.

A third insulating layer 145 is positioned on the data line 140a, the capacitor upper electrode 104b, the drain electrode 140c, the source electrode 140d, and the power supply line 140e, The third insulating layer 145 may be a planarization layer for obviating the height difference of a lower structure. The third insulating layer 145 may be formed using a method such as spin on glass (SOG) obtained by coating an organic material such as polyimide, benzocyclobutene-based resin and acrylate in the liquid form and then hardening it. Further, an inorganic material such a silicone oxide may be used. Otherwise, the third insulating layer 145 may be a passivation layer, and may include a silicon oxide (SiO_{X}) layer, a silicon nitride (SiN_{X}) layer, or a multi-layered structure including a combination thereof.

A via hole 165 is positioned inside the third insulating layer 145 to expose any one of the source and drain electrodes 140c and 140d. The first electrode 160 is positioned on the third insulating layer 145 to be electrically connected to any one of the source and drain electrodes 140c and 140d via the via hole 165.

The first electrode 160 may be an anode electrode. In case that the organic light emitting device has a bottom emission or dual emission structure, the first electrode 160 may be formed of a transparent material such as indium-tin-oxide (ITO), indium-zinc-oxide (IZO), or zinc oxide (ZnO). In case that the organic light emitting device has a top emission structure, the first electrode 160 may include a layer formed of one of ITO, IZO or ZnO, and a reflective layer formed of one of Al, Ag or Ni under the layer. Further, the first electrode 160 may have a multi-layered structure in which the reflective layer is positioned between two layers formed of one of ITO, IZO or ZnO.

A fourth insulating layer 155 including an opening 175 is positioned on the first electrode 160. The opening 175 provides electrical insulation between the neighboring first electrodes 160 and exposes a portion of the first electrode 160. A light emitting layer 170 is positioned on the first electrode 160 exposed by the opening 175.

A second electrode 180 is positioned on the light emitting layer 170. The second electrode 180 may be a cathode electrode, and may be formed of Mg, Ca, Al and Ag having a low work function or a combination thereof. In case that the organic light emitting device has a top emission or dual emission structure, the second electrode 180 may be thin enough to transmit light. In case that the organic light emitting device has a bottom emission structure, the second electrode 180 may be thick enough to reflect light.

The organic light emitting device according to the exemplary embodiment using a total of 7 masks was described as an example. The 7 masks may be used in a process for forming each of the semiconductor layer, the gate electrode (including the scan line and the capacitor lower electrode), the contact holes, the source and drain electrodes (including the data line, the power supply line and the capacitor upper electrode), the via holes, the first electrode, and the opening.

An example of how an organic light emitting device is formed using a total of 5 masks will now be given.

As shown in FIG. 12B, the buffer layer 105 is positioned on the substrate 100, and the semiconductor layer 111 is positioned on the buffer layer 105. The first insulating layer 115 is positioned on the semiconductor layer 111. The gate electrode 120c, the capacitor lower electrode 120b, and the scan line 120a are positioned on the first insulating layer 115. The second insulating layer 125 is positioned on the gate electrode 120c.

The first electrode 160 is positioned on the second insulating layer 125, and the contact holes 130b and 1 30c are positioned to expose the semiconductor layer 111. The first electrode 160 and the contact holes 130b and 130c may be simultaneously formed.

The source electrode 140d, the drain electrode 140c, the data line 140a, the capacitor upper electrode 140b, and the power supply line 140e are positioned on the second insulating layer 125. A portion of the drain electrode 140c may be positioned on the first electrode 160.

A pixel or subpixel definition layer or the third insulating layer 145, which may be a bank layer, is positioned on the substrate 110 on which the above-described structure is formed. The opening 175 is positioned on the third insulating layer 145 to expose the first electrode 160. The light emitting layer 170 is positioned on the first electrode 160 exposed by the opening 175, and the second electrode 180 is positioned on the light emitting layer 170.

The aforementioned organic light emitting device can be manufactured using a total of 5 masks. The 5 masks are used in a process for forming each of the semiconductor layer, the gate electrode (including the scan line and the capacitor lower electrode), the first electrode (including the contact holes), the source and drain electrodes (including the data line, the power supply line and the capacitor upper electrode), and the opening. Accordingly, the organic light emitting device according to the exemplary embodiment can reduce the manufacturing cost by a reduction in the number of masks and can improve the efficiency of mass production.

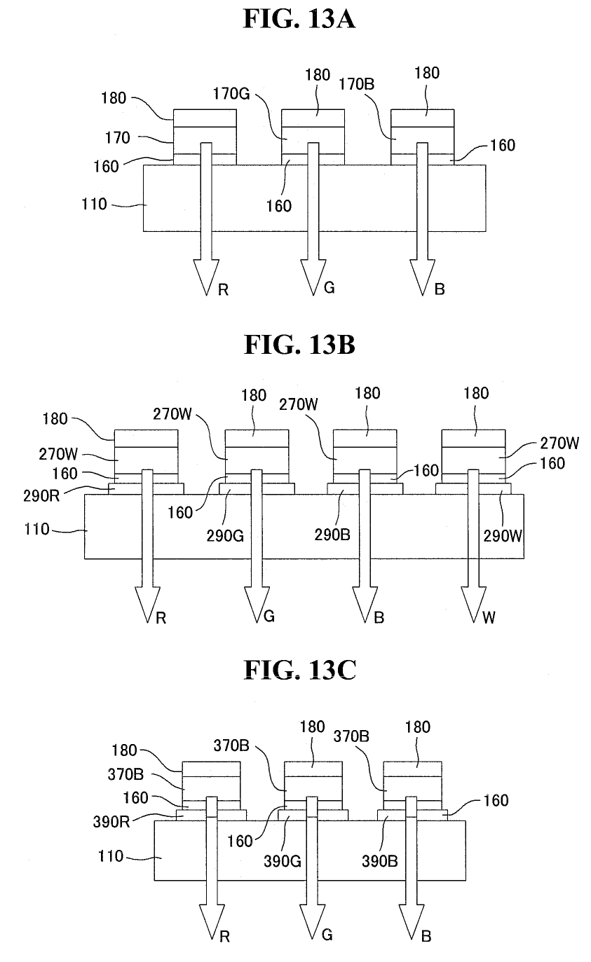

Various color image display methods may be implemented in the organic light emitting device such as described above. These methods will be described below with reference to FIGS. 13A to 13C.

FIGS. 13A to 13C illustrate various implementations of a color image display method in the organic light emitting device.

FIG. 13A illustrates a color image display method in an organic light emitting device that separately includes a red light emitting layer 170R to emit red light, a green light emitting layer 170G to emit green light, and a blue light emitting layer 170B to emit blue light. The red, green and blue light produced by the red, green and blue light emitting layers 170R, 170G and 170B is mixed to display a color image.

In FIG. 13A, the red, green and blue light emitting layers 170R, 170G and 170B may each include an electron transport layer, a hole transport layer, and the like. It is possible to variously change an arrangement and a structure between additional layers such as the electron transport layer and the hole transport layer and each of the red, green and blue light emitting layers 170R, 170G and 170B.

FIG. 13B illustrates a color image display method in an organic light emitting device including a white light emitting layer 270W, a red color filter 290R, a green color filter 290G, a blue color filter 290B, and a white color filter 290W.

As shown in FIG. 13B, the red color filter 290R, the green color filter 290G, the blue color filter 290B, and the white color filter 290W each transmit white light produced by the white light emitting layer 270W and produce red light, green light, blue light, and white light. The red, green, blue, and white light is mixed to display a color image. The white color filter 290W may be removed depending on color sensitivity of the white light produced by the white light emitting layer 270W and combination of the white light and the red, green and blue light.

While FIG. 13B has illustrated the color display method of four subpixels using combination of the red, green, blue, and white light, a color display method of three subpixels using combination of the red, green, and blue light may be used,

In FIG. 13B, the white light emitting layer 270W may include an electron transport layer, a hole transport layer, and the like. It is possible to variously change an arrangement and a structure between additional layers such as the electron transport layer and the hole transport layer and the white light emitting layer 270W.

FIG. 13C illustrates a color image display method in an organic light emitting device including a blue light emitting layer 370B, a red color change medium 390R, a green color change medium 390G, and a blue color change medium 390B.

As shown in FIG. 13C, the red color change medium 390R, the green color change medium 390G, and the blue color change medium 390B each transmit blue light produced by the blue light emitting layer 370B to produce red light, green light and blue light. The red, green and blue light is mixed to display a color image.

The blue color change medium 390B may be removed depending on color sensitivity of the blue light produced by the blue light emitting layer 370B and combination of the blue light and the red and green light.

In FIG. 13C, the blue light emitting layer 370B may include an electron transport layer, a hole transport layer, and the like. It is possible to variously change an arrangement and a structure between additional layers such as the electron transport layer and the hole transport layer and the blue light emitting layer 370B.

While FIGS. 13A to 13C have illustrated and described the organic light emitting device having a bottom emission structure, the exemplary embodiment is not limited thereto. The display device according to the exemplary embodiment may have a top emission structure, and thus can a different arrangement and a different structure depending on the top emission structure.

While FIGS. 13A to 13C have illustrated and described three kinds of color image display method, the exemplary embodiment is not limited thereto. The exemplary embodiment may use various kinds of color image display method whenever necessary.

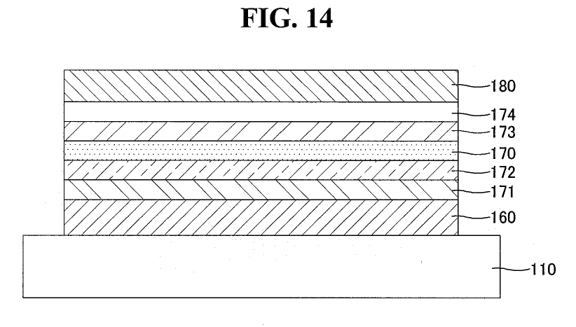

FIG. 14 is a cross-sectional view of the organic light emitting device.

As shown in FIG. 14, the organic light emitting device according to the exemplary embodiment includes the substrate 110, the first electrode 160 on the substrate 110, a hole injection layer 171 on the first electrode 160, a hole transport layer 172, a light emitting layer 170, an electron transport layer 173, an electron injection layer 174, and the second electrode 180 on the electron injection layer 174.

The hole injection layer 171 may function to facilitate the injection of holes from the first electrode 160 to the light emitting layer 170. The hole injection layer 171 may be formed of at least one selected from the group consisting of copper phthalocyanine (CuPc), PEDOT(poly(3,4)-ethylenedioxythiophene), polyaniline (PANI) and NPD(N,N-dinaphthyl-N,N′-diphenyl benzidine), but is not limited thereto. The hole injection layer 171 may be formed using an evaporation method or a spin coating method.

The hole transport layer 172 functions to smoothly transport holes. The hole transport layer 172 may be formed from at least one selected from the group consisting of NPD(N,N-dinaphthyl-N,N′-diphenyl benzidine), TPD(N,N′-bis-(3-methylphenyl)-N,N′-bis-(phenyl)-benzidine, s-TAD and MTDATA(4,4′,4″-Tris(N-3-methylphenyl-N-phenyl-amino)-triphenylamine), but is not limited thereto. The hole transport layer 172 may be formed using an evaporation method or a spin coating method.

The light emitting layer 170 may be formed of a material capable of producing red, green, blue and white light, for example, a phosphorescence material or a fluorescence material.

In case that the light emitting layer 170 produces red light, the light emitting layer 170 includes a host material including carbazole biphenyl (CBP) or N,N-dicarbazolyl-3,5-benzene (mCP). Further, the light emitting layer 170 may be formed of a phosphorescence material including a dopant material including any one selected from the group consisting of PIQIr(acac)(bis(1-phenylisoquinoline)acetylacetonate iridium), PQIr(acac)(bis(1-phenylquinoline)acetylacetonate iridium), PQIr(tris(1-phenylquinoline)iridium) and PtOEP(octaethylporphyrin platinum) or a fluorescence material including PBD:Eu(DBM)3(Phen) or Perylene, but is not limited thereto.

In case that the light emitting layer 170 produces green light, the light emitting layer 170 includes a host material including CBP or mCP. Further, the light emitting layer 170 may be formed of a phosphorescence material including a dopant material including Ir(ppy)3(fac tris(2-phenylpyridine)iridium) or a fluorescence material including Alq3(tris(8-hydroxyquinolino)aluminum), but is not limited thereto.

In case that the light emitting layer 170 produces blue light, the light emitting layer 170 includes a host material including CBP or mCP. Further, the light emitting layer 170 may be formed of a phosphorescence material including a dopant material including (4,6-F2ppy)2Irpic or a fluorescence material including any one selected from the group consisting of spiro-DPVBi, spiro-6P, distyryl-benzene (DSB), distyryl-arylene (DSA), PFO-based polymers, PPV-based polymers and a combination thereof, but is not limited thereto.

The electron transport layer 173 functions to facilitate the transportation of electrons. The electron transport layer 173 may be formed of at least one selected from the group consisting of Alq3(tris(8-hydroxyquinolino)aluminum, PBD, TAZ, spiro-PBD, BAlq, and SAlq, but is not limited thereto. The electron transport layer 173 may be formed using an evaporation method or a spin coating method.

The electron transport layer 173 can also function to prevent holes, which are injected from the first electrode 160 and then pass through the light emitting layer 170, from moving to the second electrode 180. In other words, the electron transport layer 173 serves as a hole stop layer, which facilitates the coupling of holes and electrons in the light emitting layer 170.

The electron injection layer 174 functions to facilitate the injection of electrons. The electron injection layer 174 may be formed of Alq3(tris(8-hydroxyquinolino)aluminum), PBD, TAZ, spiro-PBD, BAlq or SAlq, but is not limited thereto. The electron injection layer 174 may be formed of an organic material and an inorganic material forming the electron injection layer 174 through a vacuum evaporation method.

The hole injection layer 171 or the electron injection layer 174 may further include an inorganic material. The inorganic material may further include a metal compound. The metal compound may include alkali metal or alkaline earth metal. The metal compound including the alkali metal or the alkaline earth metal may include at least one selected from the group consisting of LiQ, LiF, NaF, KF, RbF, CsF, FrF, BeF₂, MgF₂, CaF₂, SrF₂, BaF₂, and RaF₂, but is not limited thereto.

Thus, the inorganic material inside the electron injection layer 174 facilitates hopping of electrons injected from the second electrode 180 to the light emitting layer 170, so that holes and electrons injected into the light emitting layer 170 are balanced. Accordingly, the light emission efficiency can be improved.

Further, the inorganic material inside the hole injection layer 171 reduces the mobility of holes injected from the first electrode 160 to the light emitting layer 170, so that holes and electrons injected into the light emitting layer 170 are balanced. Accordingly, the light emission efficiency can be improved.

At least one of the electron injection layer 174, the electron transport layer 173, the hole transport layer 172, the hole injection layer 171 may be omitted.

As described above, since the data driver of the organic light emitting device according to the exemplary embodiment includes the switch unit at the output terminal of the data driver, stress applied to the switch unit can be reduced by reducing the number of switch operations in the switch unit. Hence, the reliability of the switch operations of the switch unit can be improved. Further, the display quality of the organic light emitting device according to the exemplary embodiment can be improved by efficiently supplying the data signal to each subpixel.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. An organic light emitting device comprising:
a display unit on a substrate, the display unit including a plurality of subpixels;
a plurality of monitor pixels positioned outside the display unit;
a driver that supplies a data signal to the display unit in each of a plurality of subfields;
a power supply unit that supplies a power to the display unit and the monitor pixels; and
a sample hold unit connected to power terminals of the monitor pixels,
wherein when most significant bit is defined as n-bit, the sample hold unit samples a current supplied to the power terminals of the monitor pixels into a voltage in any one of the subfields corresponding to bit equal to or more than (n−2)-bit among the plurality of subfields, and transmits the sampled voltage to the power supply unit.

2. The organic light emitting device of claim 1, wherein the power supply unit controls a voltage to be supplied to the display unit based on the sampled voltage.

3. The organic light emitting device of claim 1, wherein the subfield corresponding to least significant bit and the subfield corresponding to most significant bit are randomly arranged among the plurality of subfields.

4. The organic light emitting device of claim 1, wherein the sample hold unit includes:
a first switch that performs a switch operation to supply a current to the monitor pixel;
a second switch that performs a switch operation to selectively sample the current supplied to the monitor pixel;
a capacitor that samples the current supplied to the monitor pixel into a voltage; and
an amplifier that amplifies the voltage sampled by the capacitor and transmits the amplified voltage to the power supply unit.

5. The organic light emitting device of claim 4, further comprising a controller that supplies a control signal turning on the first and second switches to the sample hold unit in any one of the subfields corresponding to bit equal to or more than (n−2)-bit.

6. An organic light emitting device comprising:
a display unit on a substrate, the display unit including a plurality of subpixels;
a plurality of monitor pixels positioned outside the display unit;
a driver that supplies a data signal to the display unit in each of a plurality of subfields of one frame, one frame including black time;
a power supply unit that supplies a power to the display unit and the monitor pixels; and
a sample hold unit connected to power terminals of the monitor pixels,
wherein the sample hold unit samples a current supplied to the power terminals of the monitor pixels into a voltage in the black time of one frame and transmits the sampled voltage to the power supply unit.

7. The organic light emitting device of claim 6, wherein the power supply unit controls a voltage to be supplied to the display unit based on the sampled voltage.

8. The organic light emitting device of claim 6, wherein the subfield corresponding to least significant bit and the subfield corresponding to most significant bit are randomly arranged among the plurality of subfields.

9. The organic light emitting device of claim 6, wherein the black time occupies the left-most period of one frame.

10. The organic light emitting device of claim 6, wherein the black time occupies the right-most period of one frame.

11. The organic light emitting device of claim 6, wherein the sample hold unit includes:
a first switch that performs a switch operation to supply a current to the monitor pixel;
a second switch that performs a switch operation to selectively sample the current supplied to the monitor pixel;
a capacitor that samples the current supplied to the monitor pixel into a voltage; and
an amplifier that amplifies the voltage sampled by the capacitor and transmits the amplified voltage to the power supply unit.

12. The organic light emitting device of claim 11, further comprising a controller that supplies a control signal turning on the first and second switches to the sample hold unit in the black time.

13. The organic light emitting device of claim 6, wherein the power supply unit includes a voltage source and a current source, and
the voltage source is used to supply a voltage to the subpixels, and the current source is used to supply a current to the monitor pixels.

14. The organic light emitting device of claim 6, wherein the subpixels include red, green, and blue subpixels, and the monitor pixels include red, green, and blue monitor pixels.

15. An organic light emitting device comprising:
a display unit on a substrate, the display unit including a plurality of subpixels;
a plurality of monitor pixels positioned outside the display unit;
a driver that supplies a data signal to the display unit in each of a plurality of subfields of one frame, each subfield including scan time and display time;
a power supply unit that supplies a power to the display unit and the monitor pixels; and
a sample hold unit connected to power terminals of the monitor pixels,
wherein the sample hold unit samples a current supplied to the power terminals of the monitor pixels into a voltage in any one of the subfields, in which the display time is longer than the scan time, and transmits the sampled voltage to the power supply unit.

16. The organic light emitting device of claim 15, wherein the power supply unit controls a voltage to be supplied to the display unit based on the sampled voltage.

17. The organic light emitting device of claim 15, wherein the subfield corresponding to least significant bit and the subfield corresponding to most significant bit are randomly arranged among the plurality of subfields.

18. The organic light emitting device of claim 15, wherein the sample hold unit includes:
a first switch that performs a switch operation to supply a current to the monitor pixel;
a second switch that performs a switch operation to selectively sample the current supplied to the monitor pixel;
a capacitor that samples the current supplied to the monitor pixel into a voltage; and
an amplifier that amplifies the voltage sampled by the capacitor and transmits the amplified voltage to the power supply unit.

19. The organic light emitting device of claim 18, further comprising a controller that supplies a control signal turning on the first and second switches to the sample hold unit in any one of the subfields, in which the display time is longer than the scan time.
